(19) United States
(12) Patent Application Publication
(10) Pub. No.: US 2026/0134605 A1
(43) Pub. Date: May 14, 2026

(54) ONLINE RENDERING OF IMAGES AND LANGUAGE FEATURES USING A GAUSSIAN SPLATTING MODEL

(71) Applicant: Robert Bosch GmbH, Stuttgart (DE)

(72) Inventors: Yuliang GUO, Redwood City, CA (US); Saimouli KATRAGADDA, Gaithersburg, MD (US); Xinyu HUANG, San Jose, CA (US); Liu REN, Saratoga, CA (US)

(21) Appl. No.: 18/947,038

(22) Filed: Nov. 14, 2024

(51) Int. Cl. G06T 15/00

(52) U.S. Cl. CPC G06T 15/005; G06T 2215/12

(57) ABSTRACT

Methods and systems for executing an online Gaussian Splatting model for simultaneous localization and mapping of a surrounding 3D space are disclosed. The model is configured to receive an image-based data sample that depicts a first field-of-view of the 3D space, and, using a 3D Gaussian map of the model, render both a new image-based data sample that depicts a new field-of-view that is different from the first field-of-view and render corresponding language features. By incorporating a hierarchical encoder and a Contrastive Language-Image Pre-training (CLIP) model into the architecture of the online Gaussian Splatting model, the overall architecture is configured to operate at near real-time.

### TECHNICAL FIELD

The present disclosure relates to methods and systems for applying machine learning techniques to enable simultaneous localization and mapping of a three-dimensional (3D) space.

### BACKGROUND

Machine learning (ML) techniques, such as Gaussian Splatting, represent a new class of ML centered on 3D scene reconstruction and graphic renderings. While previous works, such as MonoGS and LangSplat, have attempted to enable the graphic renderings to be coupled with language features, thus enabling for open vocabulary, human-and-machine interactions, these models remain slow and cumbersome. Time for scene reconstructing and rendering, using such previous works, is such that the model is several orders of magnitude too slow to be placed into any type of commercial setting, such as with an autonomous robot or assistant that could receive instructions from a human about manipulating a surrounding environment, since the model is not able to execute at anywhere close to near real-time.

### SUMMARY

In an embodiment, a method for performing online rendering of images coupled with language features is provided. The method includes: receiving a first image-based data sample corresponding to a first field-of-view of a 3D space; executing an online Gaussian Splatting model, based on the first image-based data sample and on a current 3D Gaussian map of the online Gaussian Splatting model, to render a second image-based data sample and language features, wherein the second image-based data sample corresponds to a second field-of-view of the 3D space; providing the rendered second image-based data sample and the rendered language features for enhanced localization and mapping of the 3D space; computing a loss between the first image-based data sample and the second image-based data sample to update one or more parameters of the online Gaussian Splatting model; and providing the updated, online Gaussian Splatting model for use in rendering other images coupled with language features.

In another embodiment, a system including a processor and memory containing instructions that, when executed by the processor, cause the processor to perform these steps.

In another embodiment, a non-transitory computer-readable medium includes instructions that, when executed by a processor, cause the processor to perform these steps.

### BRIEF DESCRIPTION OF THE DRAWINGS

FIG. 1 illustrates a system for training and utilizing a machine learning model, according to some embodiments.

FIG. 2 illustrates a computer-implemented method for training and utilizing a machine learning model, according to some embodiments.

FIG. 3 illustrates a schematic of performing online Gaussian Splatting within a Simultaneous Localization And Mapping (SLAM) framework, according to some embodiments.

FIG. 4 illustrates another schematic of performing online Gaussian Splatting within a SLAM framework, according to some embodiments.

FIG. 5 is a flow diagram that illustrates a process of executing online Gaussian Splatting within a SLAM framework, according to some embodiments.

FIG. 6 is a flow diagram that illustrates another process of executing online Gaussian Splatting within a SLAM framework, according to some embodiments.

FIG. 7 illustrates a schematic diagram of an interaction between a computer-controlled machine and a control system, according to some embodiments.

FIG. 8 depicts a schematic diagram of the control system of FIG. 7 configured to control an autonomous device, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In recent years, machine learning methods for 3D Gaussian Spatting have revolutionized the field of 3D reconstruction and graphic rendering, due to its high quality of 3D scene reconstruction, and its high rendering speed (e.g. over 90 frames-per-second even for high resolution images over 1600×1600 pixels). However, although such machine learning methods may provide real time speed for rendering, the speed of scene reconstruction is far from real time. For example, previous works that implement 3D Gaussian Splatting methods would require 2-3 hours in order to reconstruct even a minute indoor 3D space scene. Thus, as previous works are completely limited by the cumbersome, offline Gaussian Splatting architecture, there could be no commercial realization of such methods.

Moreover, commercialization of such methods would also benefit from fusing language features into the 3D Gaussian Splatting architecture. However, this would even further slow the already limited, offline 3D Gaussian Splatting architectures of previous works. Not only were previous works not equipped to incorporate the labeling of language features into a 3D scene reconstruction, their simple, offline capabilities would not allow for such an fusing due to the need to extensively retrain the model each time that an immediately surrounding 3D space would change from the scenes the model was previously trained specifically for.

To overcome these challenges, the present disclosure represents a dynamic and online Gaussian Splatting architecture in which image-based data samples are received and incorporated into an existing 3D Gaussian map of the model in near real-time. Similarly, by additionally utilizing a hierarchical encoder and a Contrastive Language-Image Pre-training (CLIP) compressor to generate language feature maps in parallel, the overall architecture is able to render both additional image-based data samples from new perspectives or fields-of-view while also coupling language features to those additional image-based data samples. Moreover, as the newly received image-based data samples are incorporated into the existing 3D Gaussian map in parallel with the generation of the language feature maps, the online Gaussian Splatting architecture described herein is configured to operate at near real-time.

In particular, the online Gaussian Splatting architectures described herein are configured to render image-based data samples and corresponding language features at a rate of approximately thirty milliseconds per frame, as opposed to previous works which, due to their offline architectures, operated at slower than forty minutes per frame. The over 100× faster operation of the online Gaussian Splatting architectures described herein thus allow for the commercialization and near real-time usage of such systems and methods.

The following description continues with a general introduction to training machine learning techniques that are relevant to the methods for subsequently utilizing those trained machine learning models, such as those described herein. Next, various embodiments of the architecture and process flows of online Gaussian Splatting for simultaneous localization and mapping (SLAM) are discussed. The present disclosure then demonstrates the versatility of the methods and systems described herein for incorporation into an autonomous robot.

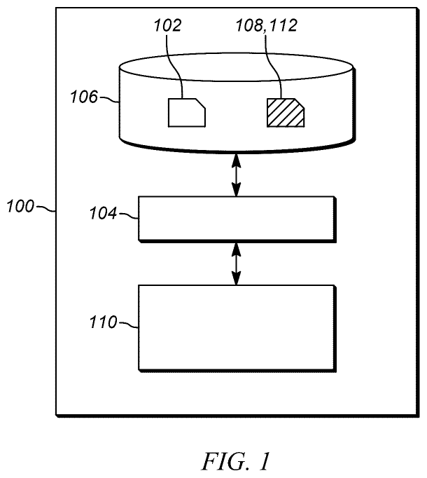

FIG. 1 illustrates a system for training and utilizing a machine learning model, according to some embodiments.

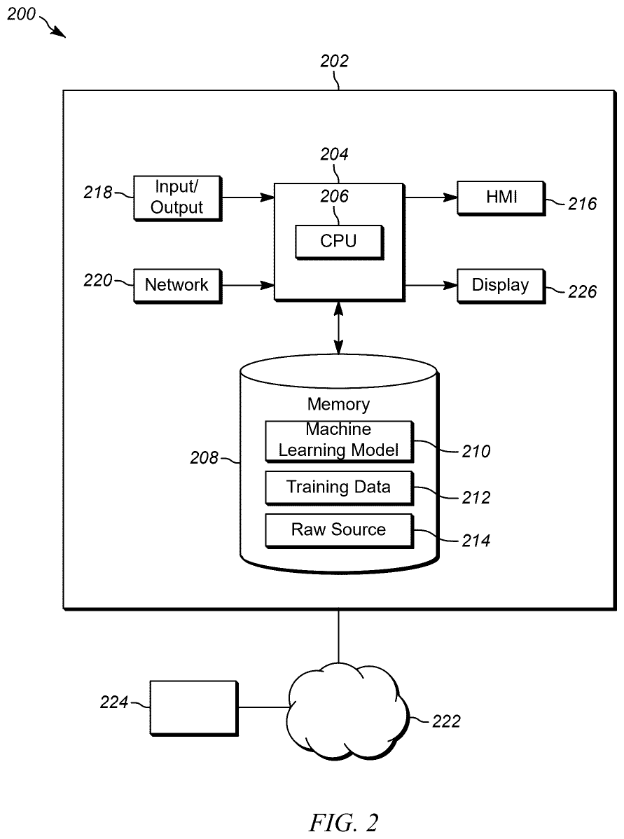

It should be understood that, while the example embodiments given in the following paragraphs herein with regard to FIGS. 1 and 2 refer to a convolutional neural network, additional embodiments of FIGS. 1 and 2 may be applied to any other type of neural-network-based or non-neural-network-based machine learning model, or transformer network, etc. that is configured to be developed, trained, and fine-tuned for various simultaneous localization and mapping applications that are further described herein.

Moreover, and as related to the description herein, a “convolutional” neural network, may be defined as having multiple self-attention and cross-attention layers in between an input layer and an output layer of the model. A convolutional neural network model may additionally be used to describe an architecture of a CLIP compressor, a super-resolution CLIP compressor, or a hierarchical encoder.

In some embodiments, the system 100 may comprise an input interface for accessing training dataset 102 (e.g., the COCO training dataset) for the convolutional neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the pre-trained convolutional neural network may also each be accessed from a different data storage, e.g., via a different subsystem of the data storage interface 104. Each subsystem may be of a type as is described above for the data storage interface 104. In other embodiments, the data representation 108 of the pre-trained convolutional neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the convolutional neural network to be fine-tuned. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively fine-tune the convolutional neural network using the training data 102 (e.g., thus generating updated versions of the machine learning model with respect to a first “pre-trained” version of the model). Here, an iteration of the training by the processor subsystem 110 may comprise a forward propagation part and a reverse, or generation, propagation part. The system 100 may further comprise an output interface for outputting a data representation 112 of the fine-tuned convolutional neural network, this data may also be referred to as both trained and fine-tuned model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘pre-trained’ convolutional neural network may during or after the training be replaced, at least in part by the data representation 112 of the trained neural network, in that the parameters of the convolutional neural network, such as weights, hyperparameters, and other types of parameters of convolutional neural networks, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘pre-trained’ convolutional neural network. In some embodiments, the output interface may be separate from the data storage interface 104, but may in general be of a type as described above for the data storage interface 104.

The system 100 shown in FIG. 1 is one example of a system that may be utilized to train one or more of the machine learning models described herein.

FIG. 2 illustrates a computer-implemented method for utilizing a machine learning model, according to some embodiments.

FIG. 2 illustrates a computer-implemented method for training, fine-tuning, and utilizing a convolutional neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training and/or fine-tuning dataset 212 for the machine learning model 210, raw source dataset 214, etc.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. In some examples, the machine learning algorithm 210 may be a convolutional neural network algorithm that is designed to perform a predetermined function.

The computer system 200 may store a training and/or fine-tuning dataset 212 for the machine learning algorithm 210. The training dataset 212 may represent a set of previously constructed data for training the machine learning algorithm 210. The training dataset 212 may be used by the machine learning algorithm 210 to learn weighting factors associated with a convolutional neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature. The raw source data 214 may be derived from a variety of sources. For example, the raw source data 214 may be actual input data collected by a machine learning system. The raw source data 214 may be machine generated for testing the system. As an example, the raw source data 214 may include image-based data samples of a given 3D space from one or more fields-of-view.

In the example, the machine learning algorithm 210 may then process raw source data 214 and output rendered image-based data samples from other fields-of-view and corresponding language features. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

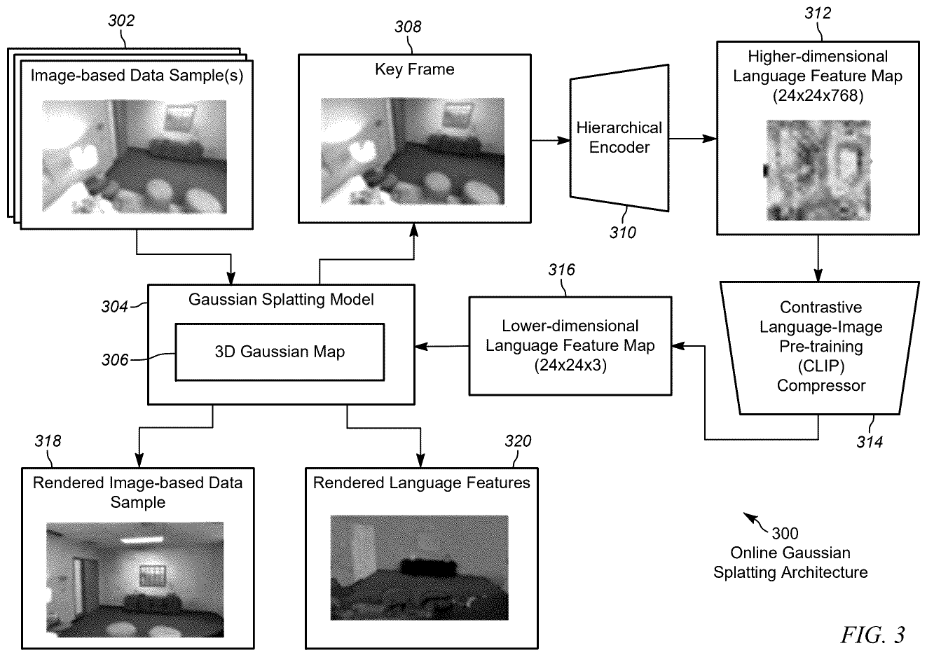

FIG. 3 illustrates a schematic of performing online Gaussian Splatting within a Simultaneous Localization And Mapping (SLAM) framework, according to some embodiments.

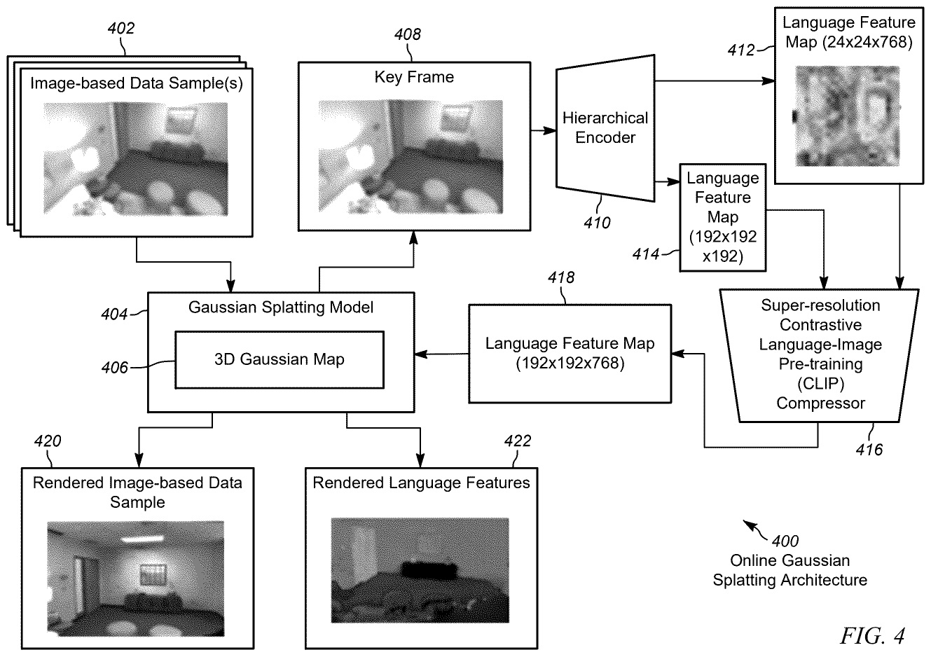

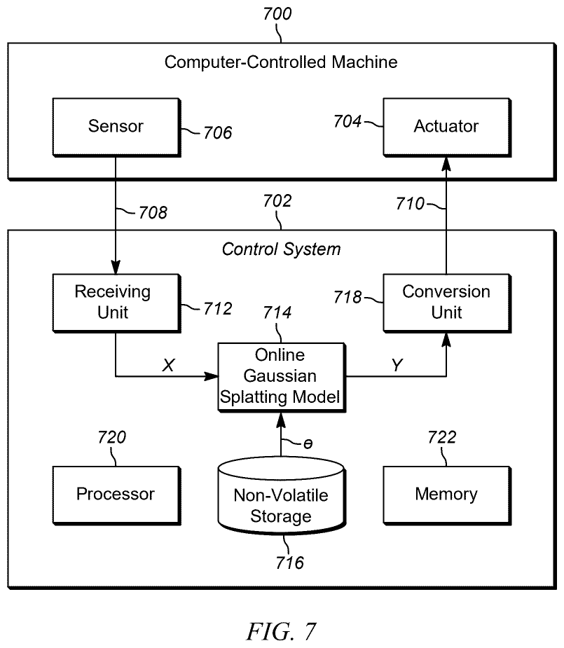

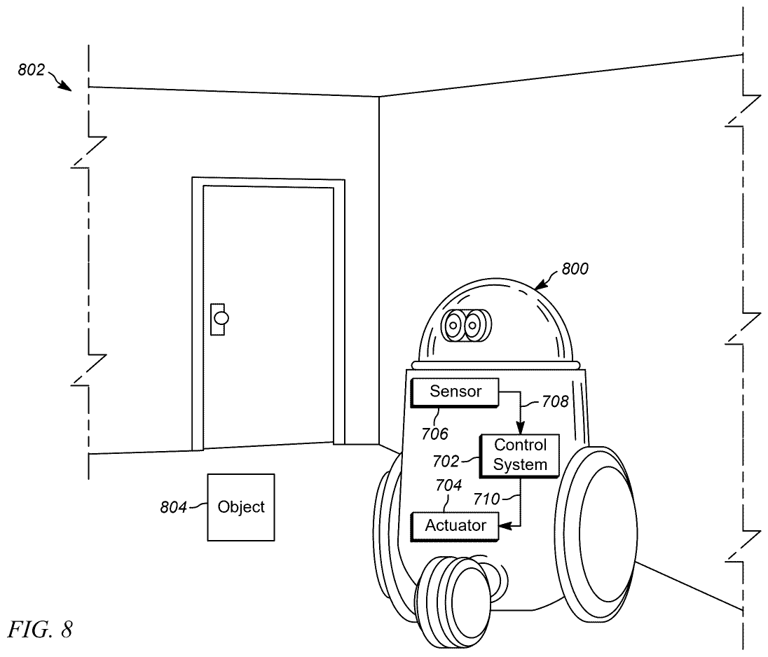

Embodiments illustrated in FIGS. 3 and 4 of online Gaussian Splatting architectures 300 and 400, respectively, may be configured to be executed using computing system 202. Furthermore, such a computing system may refer to that which is incorporated into control system 702, which is additionally described with regard to FIGS. 7 and 8 below.

Moreover, in the following description of FIGS. 3-7 herein, image-based data samples refer to either color (RGB) images, or to color and corresponding depth (RGB-D) images. In the particular embodiments shown in FIGS. 3 and 4, color (RGB) images have been illustrated. However, it should be understood that similar embodiments that instead refer to color and corresponding depth (RGB-D) images may similarly be used as inputs to architectures 300 and 400, and are thus meant to be incorporated into the discussion herein. Similarly, the 3D space referred to with regard to the illustrations in FIGS. 3 and 4, namely an indoor living room space, will be referred to herein for ease of discussion. However, other indoor and outdoor spaces (e.g., an indoor kitchen space, an indoor warehouse or manufacturing facility space, or an outdoor residential area, etc.) may similarly be incorporated into 3D Gaussian maps of online Gaussian Splatting architectures 300 and 400, and are thus meant to be incorporated into the discussion herein. Additional examples of such 3D spaces are also discussed with regard to FIGS. 7 and 8 herein.

As illustrated in online Gaussian Splatting architecture 300, one or more image-based data samples 302 may be provided to a Gaussian Splatting pipeline that is configured to output rendered image-based data sample 318 and rendered language features 320. The Gaussian Splatting pipeline includes a Gaussian Splatting model 304, a hierarchical encoder 310, and a CLIP compressor 314 in order to generate rendered image-based data sample 318 and rendered language features 320. Moreover, a first process depicted by image-based data samples 302, Gaussian Splatting model 304, and rendered image-based data sample 318, and a second process depicted by image-based data samples 302, Gaussian Splatting model 304, key frame 308, hierarchical encoder 310, higher-dimensional language feature map 312, CLIP compressor 314, lower-dimensional language feature map 316, and rendered language features 320, may be configured to be executed in parallel, according to some embodiments. Thus, online Gaussian Splatting architecture 300 may be configured to run at near real-time.

The following paragraphs discuss the first and second processes of online Gaussian Splatting architecture 300, respectively.

In some embodiments, Gaussian Splatting model 304 may be configured to output rendered image-based data sample 318 using at least the following steps. Upon receiving a new image-based data sample 302, Gaussian Splatting model 304 performs camera tracking and pose estimation based on the received image-based data sample 302. Next, and upon determining that the image-based data sample 302 is to be treated as a key frame, which is additionally described below with regard to key frame 308 and the second process of online Gaussian Splatting architecture 300, one or more new 3D Gaussian parameters are inserted or merged with other 3D Gaussian parameters of a current 3D Gaussian map 306 of Gaussian Splatting model 304. Furthermore, one or more of the new 3D Gaussian parameters may be pruned or otherwise removed if said parameter(s) are in conflict with the other, already existing 3D Gaussian parameters, according to some embodiments.

Moreover, a “current” 3D Gaussian map refers to a state of the 3D Gaussian map 306 at a moment in time in which image-based data sample 302 is received by the model. As one or more 3D Gaussian parameters of the 3D Gaussian map 306 may be updated, changed, or otherwise removed during a given iteration of rendering image-based data sample 318 and language features 320, the state of the 3D Gaussian map 306 may therefore evolve through time due to the online learning processes described herein.

Continuing with the execution of the first process of online Gaussian Splatting architecture 300, rendered image-based data sample 318 is then generated. As illustrated in FIG. 3, image-based data sample 302 may comprise pixel data of a first field-of-view of a given 3D space, such as the living room shown in the figure, while rendered image-based data sample 318 comprises rendered pixel data of a second, different field-of-view of the given 3D space.

Once rendered image-based data sample 318 is output from Gaussian Splatting model 304, one or more of the 3D Gaussian parameters of Gaussian Splatting model 304 may be updated or otherwise optimized by computing loss and performing backpropagation of gradients. Thus, 3D Gaussian parameters used to render image-based data sample 318 are incorporated into the updated 3D Gaussian map 306 of Gaussian Splatting model 304.

Moreover, Gaussian Splatting Model 304 is additionally configured to output rendered language features 320 that correspond to language features within rendered image-based data sample 318 based on (1) determining that a given new image-based data sample is a key frame, (2) executing a hierarchical encoder 310, and then (3) executing a CLIP compressor 314 in order to output a language feature map that enables the output of rendered language features 320 (e.g., the “second” process depicted in FIG. 3 that was introduced in a preceding paragraph).

Upon reception of image-based data sample 302, Gaussian Splatting model is configured to determine whether or not image-based data sample 302 is to be labeled as a key frame. This particular step in the second process is directed towards determining whether or not the incoming image-based data sample 302 constitutes a field-of-view that is substantially different from the fields-of-view already generated, rendered, and/or existing within the 3D Gaussian map 306 of Gaussian Splatting model 304. For example, if a newly incoming image-based data sample resembles an image of the 3D space with a field-of-view that has a substantial overlap with a field-of-view that may already be rendered based on the current 3D Gaussian map 306, then Gaussian Splatting model 304 may not proceed with attempting to incorporate this newly incoming image-based data sample into the current 3D Gaussian map 306 due to redundancy, and rather await reception of other image-based data samples.

In order to perform such a determination of key frame status, Gaussian Splatting model 304 is configured to compute a co-visibility ratio between the field-of-view of image-based data sample 302 and the current 3D Gaussian map 306 of the model. If the co-visibility ratio is below a given threshold, e.g., a threshold of 0.7, then the field-of-view of image-based data sample 302 indicates a substantially new field-of-view of the 3D space that has not been yet captured within the current 3D Gaussian map 306. Gaussian Splatting model 304 is thus configured to label image-based data sample 302 as a key frame 308, and proceed with providing key frame 308 to hierarchical encoder 310.

In some embodiments, and as illustrated using the multiple image-based data samples 302 in FIG. 3, more than one image-based data sample may be provided to Gaussian Splatting model 304 at a given moment in time. In such embodiments, Gaussian Splatting model may be configured to determine if the first of the image-based data samples 302 is or is not a key frame, and, if yes, proceed with labeling the first data sample as a key frame 308, and, if not, then determine if the second of the image-based data samples 302 is or is not a key frame, etc. If none of the images of image-based data samples 302 are determined to be key frames, then Gaussian Splatting model 304 awaits the reception of additional image-based data samples before proceeding with the second process depicted in online Gaussian Splatting architecture 300.

Following the labeling of image-based data sample 302 as a key frame 308, that image-based data sample is then provided to hierarchical encoder 310. In some embodiments, hierarchical encoder 310 may resemble an encoder such as the encoder within a simple-encoder-decoder (SED) architecture, or similar architecture that is configured for two-dimensional (2D) segmentation. A supervised training method may be performed using the SED architecture such that, when 2D semantic masks and language inputs are provided, an internal dense map may be aligned with language features at respective pixels within image-based data sample 302. In embodiments in which hierarchical encoder 310 resembles an encoder within a SED architecture, the training dataset may refer to a COCO training dataset, or similar.

As illustrated in FIG. 3, hierarchical encoder 310 is executed in order to output higher-dimensional language feature map 312. As will be additionally described in the following paragraphs, language feature map 312 is termed as having a higher dimension with respect to lower-dimensional language feature map 316 that is output following execution of CLIP compressor 314. Moreover, higher-dimensional language feature map 312 may additionally be referred to as an F_{V} map in vector format, according to some embodiments.

The CLIP map that has been generated using hierarchical encoder 310 of SED, and is illustrated by language feature map 312 in FIG. 3, may comprise three dimensions, wherein a first dimension refers to a pixel height dimension, the second dimension refers to a pixel width dimension, and the third dimension refers to a language feature dimension. For example, higher-dimensional language feature map 312 may have the following dimensions: 24×24×768. The first and second dimensions, namely the pixel height and width dimensions, may additionally be collectively referred to herein as spatial resolution.

Higher-dimensional language feature map 312 is then provided for execution of CLIP compressor 314, which, when executed, outputs a lower-dimensional language feature map 316. Similarly to higher-dimensional language feature map 312, lower-dimensional language feature map 316 may comprise three dimensions, wherein a first dimension refers to a pixel height dimension, the second dimension refers to a pixel width dimension, and the third dimension refers to a language feature dimension. For example, lower-dimensional language feature map 316 may have the following dimensions: 24×24×3, in which the language feature dimension has been compressed with respect to the language feature dimension 768 of higher-dimensional language feature map 312.

In some embodiments, and prior to the moment in time depicted in FIG. 3 in which online Gaussian Splatting architecture 300 is currently receiving image-based data sample 302 and rendering rendered image-based data sample 318 and rendered language features 320, CLIP compressor 314 may be trained, such that CLIP compressor 314 resembles a “trained” or “pre-trained” CLIP compressor at the moment in time depicted in FIG. 3. Description pertaining to the training of CLIP compressor are also discussed above with regard to FIGS. 1 and 2 herein. In such embodiments, a training dataset may be provided and executed by the CLIP compressor, wherein the training dataset may resemble the same training dataset as has been used to train hierarchical encoder 310 (e.g., a COCO training dataset).

Lower-dimensional language feature map 316 is then provided to Gaussian Splatting model 304.

At a same or sequential moment in time at which rendered image-based data sample 318 is output from Gaussian Splatting model 304, rendered language features 320 are also output from the model. In some embodiments, rendered language features 320 refer to semantic shape boundaries between respective objects or concept regions of the 3D space. For example, within the living room 3D space depicted in image-based data samples of FIG. 3, rendered language features 320 may include semantic shape boundaries between a lamp, a couch cushion, an ottoman, and other objects within the captured images.

In addition, an L2 loss may be computed between lower-dimensional language feature map 316 and rendered language features 320 in order to update one or more parameters of Gaussian Splatting model 304 through backpropagation, wherein the one or more parameters are Gaussian parameters used to encode language features specifically.

In some embodiments, online Gaussian Splatting architecture 300, when executed, is configured to operate at a speed of approximately three frames per second (FPS), or approximately thirty milliseconds per frame, when rendering new image-based data samples that are coupled to language features. In contrast, previous works that had no online capabilities and relied strictly on offline Gaussian Splatting methods only operated at more than forty minutes per frame. Thus, online Gaussian Splatting architecture 300 is configured to operate at approximately 100× faster than previous works.

FIG. 4 illustrates another schematic of performing online Gaussian Splatting within a SLAM framework, according to some embodiments.

In some embodiments, and in order to decrease a potential for noisy rendered language features 320 due to the rather coarse language integration of the 24×24 dimensions of higher-dimensional language feature map 312, a quality of rendered language features that are fused with 3D scene reconstruction may be gained by using online Gaussian Splatting architecture 400. In the description that follows, a super-resolution network CLIP compressor 416 may be implemented.

As illustrated in online Gaussian Splatting architecture 400, one or more image-based data samples 402 may be provided to a Gaussian Splatting pipeline that is configured to output rendered image-based data sample 420 and rendered language features 422. The Gaussian Splatting pipeline includes a Gaussian Splatting model 404, a hierarchical encoder 410, and a super-resolution CLIP compressor 416 in order to generate rendered image-based data sample 420 and rendered language features 422. Moreover, a first process depicted by image-based data samples 402, Gaussian Splatting model 404, and rendered image-based data sample 420, and a second process depicted by image-based data samples 402, Gaussian Splatting model 404, key frame 408, hierarchical encoder 410, language feature map 412, language feature map 414, super-resolution CLIP compressor 416, language feature map 418, and rendered language features 422, may be configured to be executed in parallel, according to some embodiments. Thus, online Gaussian Splatting architecture 400 may be configured to run at near real-time.

The following paragraphs discuss the first and second processes of online Gaussian Splatting architecture 400, respectively.

In some embodiments, Gaussian Splatting model 404 may be configured to output rendered image-based data sample 420 using at least the following steps. Upon receiving a new image-based data sample 402, Gaussian Splatting model 404 performs camera tracking and pose estimation based on the received image-based data sample 402. Next, and upon determining that the image-based data sample 402 is to be treated as a key frame, which is additionally described below with regard to key frame 408 and the second process of online Gaussian Splatting architecture 400, one or more new 3D Gaussian parameters are inserted or merged with other 3D Gaussian parameters of a current 3D Gaussian map 406 of Gaussian Splatting model 404. Furthermore, one or more of the new 3D Gaussian parameters may be pruned or otherwise removed if said parameter(s) are in conflict with the other, already existing 3D Gaussian parameters, according to some embodiments.

Moreover, a “current” 3D Gaussian map refers to a state of the 3D Gaussian map 406 at a moment in time in which image-based data sample 402 is received by the model. As one or more 3D Gaussian parameters of the 3D Gaussian map 406 may be updated, changed, or otherwise removed during a given iteration of rendering image-based data sample 420 and language features 422, the state of the 3D Gaussian map 406 may therefore evolve through time due to the online learning processes described herein.

Continuing with the execution of the first process of online Gaussian Splatting architecture 400, rendered image-based data sample 420 is then generated. As illustrated in FIG. 4, image-based data sample 402 may comprise pixel data of a first field-of-view of a given 3D space, such as the living room shown in the figure, while rendered image-based data sample 420 comprises rendered pixel data of a second, different field-of-view of the given 3D space.

Once rendered image-based data sample 420 is output from Gaussian Splatting model 404, one or more of the 3D Gaussian parameters of Gaussian Splatting model 404 may be updated or otherwise optimized by computing loss and performing backpropagation of gradients. Thus, 3D Gaussian parameters used to render image-based data sample 420 are incorporated into the updated 3D Gaussian map 406 of Gaussian Splatting model 404.

Moreover, Gaussian Splatting Model 404 is additionally configured to output rendered language features 422 that correspond to language features within rendered image-based data sample 420 based on (1) determining that a given new image-based data sample is a key frame, (2) executing a hierarchical encoder 410, and then (3) executing a super-resolution CLIP compressor 416 in order to output a language feature map that enables the output of rendered language features 422 (e.g., the “second” process depicted in FIG. 4 that was introduced in a preceding paragraph).

Upon reception of image-based data sample 402, Gaussian Splatting model is configured to determine whether or not image-based data sample 402 is to be labeled as a key frame. This particular step in the second process is directed towards determining whether or not the incoming image-based data sample 402 constitutes a field-of-view that is substantially different from the fields-of-view already generated, rendered, and/or existing within the 3D Gaussian map 406 of Gaussian Splatting model 404. For example, if a newly incoming image-based data sample resembles an image of the 3D space with a field-of-view that has a substantial overlap with a field-of-view that may already be rendered based on the current 3D Gaussian map 406, then Gaussian Splatting model 404 may not proceed with attempting to incorporate this newly incoming image-based data sample into the current 3D Gaussian map 406 due to redundancy, and rather await reception of other image-based data samples.

In order to perform such a determination of key frame status, Gaussian Splatting model 404 is configured to compute a co-visibility ratio between the field-of-view of image-based data sample 402 and the current 3D Gaussian map 406 of the model. If the co-visibility ratio is below a given threshold, e.g., a threshold of 0.7, then the field-of-view of image-based data sample 402 indicates a substantially new field-of-view of the 3D space that has not been yet captured within the current 3D Gaussian map 406. Gaussian Splatting model 404 is thus configured to label image-based data sample 402 as a key frame 408, and proceed with providing key frame 408 to hierarchical encoder 410.

In some embodiments, and as illustrated using the multiple image-based data samples 402 in FIG. 4, more than one image-based data sample may be provided to Gaussian Splatting model 404 at a given moment in time. In such embodiments, Gaussian Splatting model may be configured to determine if the first of the image-based data samples 402 is or is not a key frame, and, if yes, proceed with labeling the first data sample as a key frame 408, and, if not, then determine if the second of the image-based data samples 402 is or is not a key frame, etc. If none of the images of image-based data samples 402 are determined to be key frames, then Gaussian Splatting model 404 awaits the reception of additional image-based data samples before proceeding with the second process depicted in online Gaussian Splatting architecture 400.

Following the labeling of image-based data sample 402 as a key frame 408, that image-based data sample is then provided to hierarchical encoder 410. In some embodiments, hierarchical encoder 410 may resemble an encoder such as the encoder within a simple-encoder-decoder (SED) architecture, or similar architecture that is configured for two-dimensional (2D) segmentation. A supervised training method may be performed using the SED architecture such that, when 2D semantic masks and language inputs are provided, an internal dense map may be aligned with language features at respective pixels within image-based data sample 402. In embodiments in which hierarchical encoder 410 resembles an encoder within a SED architecture, the training dataset may refer to a COCO training dataset, or similar.

As illustrated in FIG. 4, hierarchical encoder 410 is executed in order to output language feature map 412 and language feature map 414. In some embodiments, language feature maps 412 and 414 may additionally be referred to as F_{V} and F₂ maps in vector format, respectively.

Similarly to that which is described with regard to language feature maps illustrated in FIG. 3, language feature maps 412 and 414 may comprise three dimensions, wherein a first dimension refers to a pixel height dimension, the second dimension refers to a pixel width dimension, and the third dimension refers to a language feature dimension. For example, language feature map 412 may have the following dimensions: 24×24×768; and language feature map 414 may have the following dimensions: 192×192×192. The first and second dimensions, namely the pixel height and width dimensions, may additionally be collectively referred to herein as spatial resolution.

Language feature map 412 and language feature map 414 are then provided for execution of the super-resolution CLIP compressor 416, which, when executed, outputs a language feature map 418. Similarly to language feature maps 412 and 414, language feature map 418 may comprise three dimensions, wherein a first dimension refers to a pixel height dimension, the second dimension refers to a pixel width dimension, and the third dimension refers to a language feature dimension. For example, language feature map 418 may have the following dimensions: 192×192×768.

In some embodiments, and prior to the moment in time depicted in FIG. 4 in which online Gaussian Splatting architecture 400 is currently receiving image-based data sample 402 and rendering rendered image-based data sample 420 and rendered language features 422, super-resolution CLIP compressor 416 may be trained, such that super-resolution CLIP compressor 416 resembles a “trained” or “pre-trained” CLIP compressor at the moment in time depicted in FIG. 4. Description pertaining to the training of super-resolution CLIP compressor are also discussed above with regard to FIGS. 1 and 2 herein. In such embodiments, a training dataset may be provided and executed by the super-resolution CLIP compressor, wherein the training dataset may resemble the same training dataset as has been used to train hierarchical encoder 410 (e.g., a COCO training dataset).

Language feature map 418 is then provided to Gaussian Splatting model 404.

At a same or sequential moment in time at which rendered image-based data sample 420 is output from Gaussian Splatting model 404, rendered language features 422 are also output from the model. In some embodiments, rendered language features 422 refer to semantic shape boundaries between respective objects or concept regions of the 3D space. For example, within the living room 3D space depicted in image-based data samples of FIG. 4, rendered language features 422 may include semantic shape boundaries between a lamp, a couch cushion, an ottoman, and other objects within the captured images.

In addition, an L2 loss may be computed between lower-dimensional language feature map 418 and rendered language features 422 in order to update one or more parameters of Gaussian Splatting model 404 through backpropagation, wherein the one or more parameters are Gaussian parameters used to encode language features specifically.

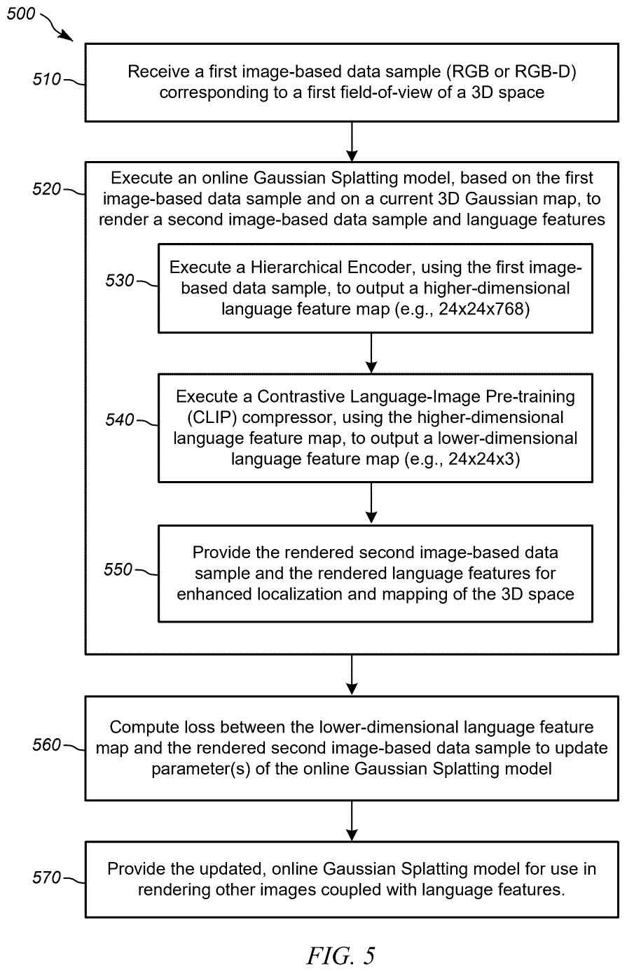

FIG. 5 is a flow diagram that illustrates a process of executing online Gaussian Splatting within a SLAM framework, according to some embodiments.

Process 500, illustrated in FIG. 5, may correspond to performance and execution of online Gaussian Splatting architecture 300, according to some embodiments.

In block 510, a first image-based data sample is received to the computing system that is executing the online Gaussian Splatting methods. In some embodiments, the first image-based data sample may resemble a color (RGB) or a color with corresponding depth (RGB-D) image, and refers to a given field-of-view of a given 3D space.

Blocks 530, 540, and 550 then refer to steps in the execution of an online Gaussian Splatting model, as indicated with block 520. In order to render a second image-based data sample and corresponding language features, the computing system is configured to first execute a hierarchical encoder, as indicated in block 530. A higher-dimensional language feature map (e.g., a map with dimensions of 24×24×768) is output from the hierarchical encoder and then provided to a CLIP compressor.

In block 540, the CLIP compressor is executed such that a lower-dimensional language feature map (e.g., a map with dimensions of 24×24×3) is output from the compressor.

In block 550, the rendered second image-based data sample and the rendered language features are provided for enhanced localization and mapping of the 3D space. For example, and as additionally described with regard to the autonomous device 800 in FIG. 8, language features of the given 3D space may be used by control system 702 to locate object 804 within the 3D space.

Upon rendering of a second image-based data sample and corresponding rendered language features, a loss is then computed between the lower-dimensional language feature map and the rendered language features, as illustrated in block 560. This loss is then used to perform backpropagation to update one or more parameters of the 3D Gaussian map of the online Gaussian Splatting model.

The updated, online Gaussian Splatting model, as indicated in block 570, may then be used in a subsequent iteration of rendering image-based data samples and corresponding language features.

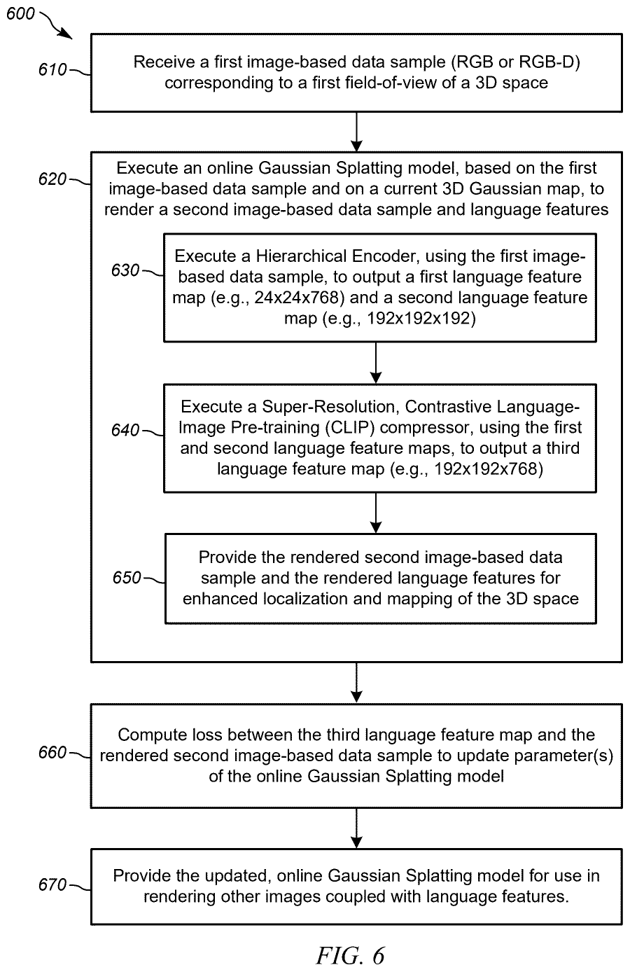

FIG. 6 is a flow diagram that illustrates another process of executing online Gaussian Splatting within a SLAM framework, according to some embodiments.

Process 600, illustrated in FIG. 6, may correspond to performance and execution of online Gaussian Splatting architecture 400, according to some embodiments.

In block 610, a first image-based data sample is received to the computing system that is executing the online Gaussian Splatting methods. In some embodiments, the first image-based data sample may resemble a color (RGB) or a color with corresponding depth (RGB-D) image, and refers to a given field-of-view of a given 3D space.

Blocks 630, 640, and 650 then refer to steps in the execution of an online Gaussian Splatting model, as indicated with block 620. In order to render a second image-based data sample and corresponding language features, the computing system is configured to first execute a hierarchical encoder, as indicated in block 630. A first language feature map (e.g., a map with dimensions of 24×24×768) is output from the hierarchical encoder along with a second language feature map (e.g., a map with dimensions of 192×192×192). Both the first and the second language feature maps may then be provided to a super-resolution CLIP compressor.

In block 640, the super-resolution CLIP compressor is executed such that a third language feature map (e.g., a map with dimensions of 192×192×768) is output from the compressor.

In block 650, the rendered second image-based data sample and the rendered language features are provided for enhanced localization and mapping of the 3D space.

Upon rendering of a second image-based data sample and corresponding rendered language features, a loss is then computed between the third language feature map and the rendered language features, as illustrated in block 660. This loss is then used to perform backpropagation to update one or more parameters of the 3D Gaussian map of the online Gaussian Splatting model.

The updated, online Gaussian Splatting model, as indicated in block 570, may then be used in a subsequent iteration of rendering image-based data samples and corresponding language features.

FIG. 7 illustrates a schematic diagram of an interaction between a computer-controlled machine and a control system, according to some embodiments.

The methods and systems disclosed herein can be used in many different applications. This section provides some practical applications of the proposed system.

Performing simultaneous localization and mapping (SLAM) enables near real-time human-machine interactions, and such techniques may incorporate the online Gaussian Splatting architecture and methods described herein.

The implementation of such a context is illustrated in FIGS. 7 and 8. FIG. 7 depicts a schematic diagram of an interaction between a computer-controlled machine 700 and a control system 702. Computer-controlled machine 700 includes actuator 704 and sensor 706. Actuator 704 may include one or more actuators and sensor 706 may include one or more sensors. Sensor 706 is configured to sense a condition of computer-controlled machine 700. Sensor 706 may resemble a color (RGB) camera or color and depth (RGB-D) camera, and may be configured to capture images at different fields-of-view of autonomous device 800. Non-limiting examples of sensor 706 include a camera, video sensor, optical sensor, and the like. In one embodiment, sensor 706 is an optical sensor configured to sense optical images of an environment proximate to computer-controlled machine 700.

Sensor 706 may be configured to encode the sensed condition into sensor signals 708 and to transmit sensor signals 708 to control system 702. Control system 702 is configured to receive sensor signals 708 from computer-controlled machine 700. As set forth below, control system 702 may be further configured to compute actuator control commands 710 depending on the sensor signals and to transmit actuator control commands 710 to actuator 704 of computer-controlled machine 700.

As shown in FIG. 7, control system 702 includes receiving unit 712. Receiving unit 712 may be configured to receive sensor signals 708 from sensor 706 and to transform sensor signals 708 into input signals x. In an alternative embodiment, sensor signals 708 are received directly as input signals x without receiving unit 712. Each input signal x may be a portion of each sensor signal 708. Receiving unit 712 may be configured to process each sensor signal 708 to product each input signal x. Input signal x may include data corresponding to an image recorded by sensor 706. For example, image-based data samples may be received to receiving unit 712.

Control system 702 includes an online Gaussian Splatting model 714. Online Gaussian Splatting model 714 may be configured to enable simultaneous localization and mapping (SLAM) of objects within a surrounding 3D space. Online Gaussian Splatting model 714 is configured to be parametrized by Gaussian parameters, such as those described above (e.g., parameter θ). Parameters θ may be stored in and provided by non-volatile storage 716. Online Gaussian Splatting model 714 is configured to determine output signals y from input signals x. Each output signal y includes information that assigns one or more labels to each input signal x. Online Gaussian Splatting model 714 may transmit output signals y to conversion unit 718. Conversion unit 718 is configured to covert output signals y into actuator control commands 710. Control system 702 is configured to transmit actuator control commands 710 to actuator 704, which is configured to actuate computer-controlled machine 700 in response to actuator control commands 710. In another embodiment, actuator 704 is configured to actuate computer-controlled machine 700 based directly on output signals y.

Upon receipt of actuator control commands 710 by actuator 704, actuator 704 is configured to execute an action corresponding to the related actuator control command 710. Actuator 704 may include a control logic configured to transform actuator control commands 710 into a second actuator control command, which is utilized to control actuator 704. In one or more embodiments, actuator control commands 710 may be utilized to control a display instead of or in addition to an actuator.

In another embodiment, control system 702 includes sensor 706 instead of or in addition to computer-controlled machine 700 including sensor 706. Control system 702 may also include actuator 704 instead of or in addition to computer-controlled machine 700 including actuator 704.

As shown in FIG. 7, control system 702 also includes processor 720 and memory 722. Processor 720 may include one or more processors. Memory 722 may include one or more memory devices. The Online Gaussian Splatting model 714 of one or more embodiments may be implemented by control system 702, which includes non-volatile storage 716, processor 720 and memory 722.

Non-volatile storage 716 may include one or more persistent data storage devices such as a hard drive, optical drive, tape drive, non-volatile solid-state device, cloud storage or any other device capable of persistently storing information. Processor 720 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 722. Memory 722 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 720 and memory 722 may be configured to provide collected data to one or more other computing devices that are configured to execute the Online Gaussian Splatting model within domain-specific embodiments that are also shown in FIG. 8. Such collected data may be used to generate training datasets and validation datasets for various stages in preparing and executing a machine learning model into industry-grade applications. Within a context described herein with regard to executing an online Gaussian Splatting model, processor 720 and memory 722 may be coupled to or otherwise remotely connected to computing devices that may then conduct human-machine interactions, such as those described with regard to FIG. 8 below.

Processor 720 may be configured to read into memory 722 and execute computer-executable instructions residing in non-volatile storage 716 and embodying one or more machine learning algorithms and/or methodologies of one or more embodiments. Non-volatile storage 716 may include one or more operating systems and applications. Non-volatile storage 716 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 720, the computer-executable instructions of non-volatile storage 716 may cause control system 702 to implement one or more of the machine learning algorithms and/or methodologies as disclosed herein. Non-volatile storage 716 may also include machine learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 8 depicts a schematic diagram of control system 702 configured to control autonomous device 800. Control system 702 may be configured to control actuator 704, which is configured to control autonomous device 800. In some embodiments, autonomous device 800 may resemble an automated personal assistant, a robotic system, or any other machine that is configured to receive and perform tasks in a human-machine interaction setting.

Sensor 706 may be an optical sensor and/or a camera sensor. The camera sensor may be configured to receive video, images, or other frames of a 3D space 802 surrounding automated personal assistant 800. An additional sensor 706 may resemble an audio sensor that is configured to receive a voice command from a locally present human. In embodiments illustrated in FIG. 8, for example, a human may provide a natural language prompt of initiate an open-vocabulary interaction with the autonomous device 800, such as providing a command for autonomous device 800 to locate object 804 within 3D space 802 and perform an action associated with the object's localization (e.g., move the object, bring the object to another region of 3D space 802, confirm that the object is still present within 3D space 802 and has not been moved, etc.).

Control system 702 of autonomous device 800 may be configured to determine actuator control commands 710 configured to control system 702. Control system 702 may be configured to determine actuator control commands 710 in accordance with sensor signals 708 of sensor 706. Autonomous device 800 is configured to transmit sensor signals 708 to control system 702. Online Gaussian Splatting model 714 of control system 702 may be configured to execute a simultaneous localization and mapping identify semantic shape boundaries of object 804, to determine actuator control commands 710, and to transmit the actuator control commands 710 to actuator 704.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for online rendering of images coupled with language features, the method comprising:
receiving a first image-based data sample corresponding to a first field-of-view of a three-dimensional (3D) space;
executing an online Gaussian Splatting model, based on the first image-based data sample and on a current 3D Gaussian map of the online Gaussian Splatting model, to render a second image-based data sample and language features, wherein the second image-based data sample corresponds to a second field-of-view of the 3D space;
providing the rendered second image-based data sample and the rendered language features for enhanced localization and mapping of the 3D space;
computing a loss between the first image-based data sample and the second image-based data sample to update one or more parameters of the online Gaussian Splatting model; and
providing the updated, online Gaussian Splatting model for use in rendering other images coupled with language features.

2. The computer-implemented method of claim 1, wherein:
the executing the online Gaussian Splatting model further comprises:
executing a hierarchical encoder, using the first image-based data sample, to output a higher-dimensional language feature map; and
executing a Contrastive Language-Image Pre-training (CLIP) compressor, using the higher-dimensional language feature map, to output a lower-dimensional language feature map; and
the method further comprises computing another loss between the lower-dimensional language feature map and the rendered language features to additionally update the one or more parameters of the online Gaussian Splatting model, wherein the one or more parameters are Gaussian parameters used to encode language features.

3. The computer-implemented method of claim 2, wherein the higher-dimensional language feature map comprises dimensions of:
a pixel height dimension of 24;
a pixel width dimension of 24; and
a language feature dimension of 768.

4. The computer-implemented method of claim 2, wherein the lower-dimensional language feature map comprises dimensions of:
a pixel height dimension of 24;
a pixel width dimension of 24; and
a language feature dimension of 3.

5. The computer-implemented method of claim 2, wherein the executing the online Gaussian Splatting model further comprises:
computing a co-visibility ratio between the first field-of-view of the first image-based data sample and the current 3D Gaussian map;
labeling the first image-based data sample as a key frame based on determining that the co-visibility ratio is below a threshold; and
providing the key frame for the execution of the hierarchical encoder.

6. The computer-implemented method of claim 2, further comprising:
providing a training dataset to the CLIP compressor, wherein the training dataset is a same training dataset as one that the hierarchical encoder has been trained on;
training the CLIP compressor using the training dataset; and
outputting the trained CLIP compressor for use in executing the online Gaussian Splatting model.

7. The computer-implemented method of claim 1, wherein:
the executing the online Gaussian Splatting model further comprises:
executing a hierarchical encoder, using the first image-based data sample, to output a first language feature map that corresponds to a first layer of the hierarchical encoder and a second language feature map that corresponds to a second layer of the hierarchical encoder; and
executing a super-resolution, Contrastive Language-Image Pre-training (CLIP) compressor, using the first and second language feature maps, to output a third language feature map; and
the method further comprises computing another loss between the third language feature map and the rendered language features to additionally update the one or more parameters of the online Gaussian Splatting model, wherein the one or more parameters are Gaussian parameters used to encode language features.

8. The computer-implemented method of claim 7, wherein the first language feature map comprises dimensions of:
a pixel height dimension of 24;
a pixel width dimension of 24; and
a language feature dimension of 768.

9. The computer-implemented method of claim 7, wherein the second language feature map comprises dimensions of:
a pixel height dimension of 192;
a pixel width dimension of 192; and
a language feature dimension of 192.

10. The computer-implemented method of claim 7, wherein the third language feature map comprises dimensions of:
a pixel height dimension of 192;
a pixel width dimension of 192; and
a language feature dimension of 768.

11. The computer-implemented method of claim 7, wherein the executing the online Gaussian Splatting model further comprises:
computing a co-visibility ratio between the first field-of-view of the first image-based data sample and the current 3D Gaussian map;
labeling the first image-based data sample as a key frame based on determining that the co-visibility ratio is below a threshold; and
providing the key frame for the execution of the hierarchical encoder.

12. The computer-implemented method of claim 7,
providing a training dataset to the super-resolution, CLIP compressor, wherein the training dataset is a same training dataset as one that the hierarchical encoder has been trained on;
training the super-resolution, CLIP compressor using the training dataset; and
outputting the trained, super-resolution, CLIP compressor for use in executing the online Gaussian Splatting model.

13. The computer-implemented method of claim 1, wherein the first image-based data sample comprises:
a color (RGB) image; or
a color and corresponding depth (RGB-D) image.

14. The computer-implemented method of claim 1, wherein the rendered language features comprise semantic shape boundaries between respective objects or concept regions of the 3D space.

15. A non-transitory, computer-readable medium storing program instructions that, when executed on or across a processor, cause the processor to:
receive a first image-based data sample corresponding to a first field-of-view of a three-dimensional (3D) space;
execute an online Gaussian Splatting model, based on the first image-based data sample and on a current 3D Gaussian map of the online Gaussian Splatting model, to render a second image-based data sample and language features, wherein the second image-based data sample corresponds to a second field-of-view of the 3D space;
provide the rendered second image-based data sample and the rendered language features for enhanced localization and mapping of the 3D space;
compute a loss between the first image-based data sample and the second image-based data sample to update one or more parameters of the online Gaussian Splatting model; and
provide the updated, online Gaussian Splatting model for use in rendering other images coupled with language features.

16. The non-transitory, computer-readable medium of claim 15, wherein:
to execute the online Gaussian Splatting model, the program instructions cause the processor to:
execute a hierarchical encoder, using the first image-based data sample, to output a higher-dimensional language feature map; and
execute a Contrastive Language-Image Pre-training (CLIP) compressor, using the higher-dimensional language feature map, to output a lower-dimensional language feature map; and
the program instructions further cause the processor to compute another loss between the lower-dimensional language feature map and the rendered language features to additionally update the one or more parameters of the online Gaussian Splatting model, wherein the one or more parameters are Gaussian parameters used to encode language features.

17. The non-transitory, computer-readable medium of claim 15, wherein:
to execute the online Gaussian Splatting model, the program instructions cause the processor to:
execute a hierarchical encoder, using the first image-based data sample, to output a first language feature map that corresponds to a first layer of the hierarchical encoder and a second language feature map that corresponds to a second layer of the hierarchical encoder; and
execute a super-resolution, Contrastive Language-Image Pre-training (CLIP) compressor, using the first and second language feature maps, to output a third language feature map; and
the program instructions further cause the processor to compute another loss between the third language feature map and the rendered language features to additionally update the one or more parameters of the online Gaussian Splatting model, wherein the one or more parameters are Gaussian parameters used to encode language features.

18. An autonomous device, comprising:
a color (RGB) camera, configured to capture fields-of-view of a three-dimensional (3D) space surrounding the autonomous device;
a processor; and
memory storing program instructions that, when executed by the processor, cause the processor to:
receive a request to locate an object and subsequently perform an action based on locating the object;
receive a first image-based data sample from the color camera, wherein the first image-based data sample corresponds to a first field-of-view;
execute an online Gaussian Splatting model, based on the first image-based data sample, to render a second image-based data sample and language features, wherein:
the rendered second image-based data sample corresponds to a second field-of-view of the 3D space; and
the rendered language features comprise semantic shape boundaries between the object and other objects in the 3D space; and
perform the action based on the semantic shape boundary of the object within the 3D space.

19. The autonomous device of claim 18, wherein, to execute the online Gaussian Splatting model, the program instructions cause the processor to:
execute a hierarchical encoder, using the first image-based data sample, to output a higher-dimensional language feature map;
execute a Contrastive Language-Image Pre-training (CLIP) compressor, using the higher-dimensional language feature map, to output a lower-dimensional language feature map; and
compute a loss between the lower-dimensional language feature map and the rendered language features to update one or more parameters of the online Gaussian Splatting model.

20. The autonomous device of claim 18, wherein, to execute the online Gaussian Splatting model, the program instructions cause the processor to:
execute a hierarchical encoder, using the first image-based data sample, to output a first language feature map that corresponds to a first layer of the hierarchical encoder and a second language feature map that corresponds to a second layer of the hierarchical encoder; and
execute a super-resolution, Contrastive Language-Image Pre-training (CLIP) compressor, using the first and second language feature maps, to output a third language feature map; and
compute a loss between the third language feature map and the rendered language features to update one or more parameters of the online Gaussian Splatting model.
